(19) United States
(12) Patent Application Publication
(10) Pub. No.: US 2026/0019468 A1
(43) Pub. Date: Jan. 15, 2026

(54) THIRD-PARTY SERVICE MANAGEMENT METHOD, AND APPARATUS

(71) Applicant: BEIJING XIAOMI MOBILE SOFTWARE CO., LTD., Beijing (CN)

(72) Inventors: Dong CHEN, Beijing (CN); Zhibin HE, Beijing (CN)

(73) Assignee: BEIJING XIAOMI MOBILE SOFTWARE CO., LTD., Beijing (CN)

(21) Appl. No.: 18/994,734

(22) PCT Filed: Jul. 25, 2022
(86) PCT No.: PCT/CN2022/107714

§ 371 Date: Jan. 15, 2025

(51) Int. Cl. H04L 67/53

(52) U.S. Cl. CPC H04L 67/53

(57) ABSTRACT

A third-party service management method includes: receiving a first management request for managing a third-party service sent by an application function (AF) element, in which, the first management request indicates the third-party service that is provided by a third-party application; managing the third-party service based on the first management request; and sending a management result to the AF element.

### CROSS-REFERENCE TO RELATED APPLICATIONS

This application is a U.S. National Phase of International Application No. PCT/CN2022/107714, filed Jul. 25, 2022, the entire content of which is incorporated herein by reference.

### TECHNICAL FIELD

The disclosure relates to a field of communication technologies, in particular to a third-party service management method/apparatus.

### BACKGROUND

In future network systems, a variety of new services (such as an artificial intelligence (AI) service, a perception service, etc.) will be introduced to improve richness of network services. These new services may be provided by nodes within a network or by third parties external to the network.

### SUMMARY

According to a first aspect of embodiments of the disclosure, a third-party service management method is provided. The method is performed by a network exposure function (NEF) element, and includes:

receiving a first management request for managing a third-party service sent by an application function (AF) element, in which the first management request indicates the third-party service that is provided by a third-party application:

managing the third-party service based on the first management request; and sending a management result to the AF element.

According to a second aspect of embodiments of the disclosure, a third-party service management method is provided. The method is performed by a network repository function (NRF) element, and includes:

receiving a second management request for managing a third-party service sent by a NEF element, in which the second management request indicates the third-party service that is provided by a third-party application:

managing the third-party service based on the second management request: and sending a management result to the NEF element.

According to a third aspect of embodiments of the disclosure, a third-party service management method is provided. The method is performed by an AF element, and includes:

sending a first management request for managing a third-party service to an NEF element, in which the first management request indicates the third-party service that is provided by a third-party application; and receiving a management result sent by the NEF element.

### BRIEF DESCRIPTION OF THE DRAWINGS

The above-mentioned and/or additional aspects and advantages of the disclosure will be apparent and easily understood from the following description of embodiments in combination with the accompanying drawings, in which:

FIG. 1 is a structural diagram of a communication system according to an embodiment of the disclosure.

FIG. 2 is a flowchart of a third-party service management method provided by another embodiment of the disclosure.

FIG. 3 is a flowchart of a third-party service management method provided by yet another embodiment of the disclosure.

FIG. 4 is a flowchart of a third-party service management method provided by still another embodiment of the disclosure.

FIG. 5 is a flowchart of a third-party service management method provided by another embodiment of the disclosure.

FIG. 6 is a flowchart of a third-party service management method provided by yet another embodiment of the disclosure.

FIG. 7 is a flowchart of a third-party service management method provided by still another embodiment of the disclosure.

FIG. 8 is a flowchart of a third-party service management method provided by an embodiment of the disclosure.

FIG. 9 is a flowchart of a third-party service management method provided by another embodiment of the disclosure.

FIG. 10 is a flowchart of a third-party service management method provided by yet another embodiment of the disclosure.

FIG. 11 is a flowchart of a third-party service management method provided by still another embodiment of the disclosure.

FIG. 12 is a flowchart of a third-party service management method provided by another embodiment of the disclosure.

FIG. 13 is a flowchart of a third-party service management method provided by yet another embodiment of the disclosure.

FIG. 14 is a flowchart of a third-party service management method provided by still another embodiment of the disclosure.

FIG. 15 is a flowchart of a third-party service management method provided by another embodiment of the disclosure.

FIG. 16 is a flowchart of a third-party service management method provided by yet another embodiment of the disclosure.

FIG. 17 is a flowchart of an interaction method of third-party service registration provided by another embodiment of the disclosure.

FIG. 18 is a flowchart of an interaction method of third-party service cancellation provided by yet another embodiment of the disclosure.

FIG. 19 is a schematic diagram of a communication device provided by an embodiment of the disclosure.

FIG. 20 is a schematic diagram of a communication device provided by another embodiment of the disclosure.

FIG. 21a is a schematic diagram of a communication device provided by an embodiment of the disclosure.

FIG. 21b is a schematic diagram of a communication system provided by an embodiment of the disclosure.

FIG. 22 is a block diagram of a user equipment provided by an embodiment of the disclosure.

FIG. 23 is a block diagram of a network-side device provided by an embodiment of the disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of embodiments do not represent all implementations consistent with embodiments of the disclosure. Instead, they are merely examples of apparatuses and methods consistent with aspects related to the disclosure as recited in the appended claims.

The terms used in the disclosure are only for the purpose of describing specific embodiments, and are not intended to limit embodiments of the disclosure. The singular forms of “a” and “the” used in the disclosure are also intended to include plural forms, unless the context clearly indicates other meanings. It is understandable that the term “and/or” as used herein refers to and includes any or all possible combinations of one or more associated listed items.

It is understandable that although the terms “first”, “second”, and “third” may be used in embodiments of the disclosure to describe various types of information, the information should not be limited to these terms. These terms are only used to distinguish the same type of information from each other. For example, without departing from the scope of the disclosure, the first information may also be referred to as the second information, and similarly, the second information may also be referred to as the first information. Depending on the context, the terms “if” and “in case of” as used herein may be interpreted as “when”, “upon” or “in response to determining”.

Embodiments of the disclosure are described in detail below, examples of which are illustrated in the accompanying drawings, in which the same or similar reference numerals refer to the same or similar elements throughout. The embodiments described below with reference to the accompanying drawings are exemplary and are intended to be used to explain the disclosure, but should not be constructed as limiting the disclosure.

To facilitate understanding, the terms involved in the present disclosure are first introduced.

### 1. Artificial Intelligence (AI)

AI is a new technical science that studies and develops theories, methods, technologies and application systems for simulating, extending and expanding human intelligence.

### 2. Network Repository Function (NRF) Element

The NRF element stores and maintains network function (NF) information in a network and provides an NF discovery/selection/subscription function, for example, requesting to the NRF for information about a certain NF, such as an Internet protocol (IP) address.

### 3. Network Exposure Function (NEF) Element

The NEF element safely opens services provided by other NFs in the network to a third parties, application functions (AFs), etc., and safely transmits information sent by AFs to the network, which plays the role of a service layer security gateway.

### 4. AF Element

The AF element refers to a network element that provides applications, and authorization servers may be deployed as the AF elements.

The network elements/functions involved in embodiments of the disclosure may be independent hardware devices or functions realized by computer codes in the hardware devices, which is not limited in the embodiment of the disclosure.

In order to better understand a third-party service management method disclosed in an embodiment of the disclosure, a communication system to which the embodiment of the disclosure applies will be described below.

A 5G (5^{th} generation) service network architecture abstracts functions of network elements into a plurality of services. Compared with traditional network architectures, two new network elements, including the NEF element and the NRF element, are added to the 5G service network architecture. The NEF may safely provide services and capabilities of 3rd Generation Partnership Project (3GPP) network elements to external objects, and is regarded as a security gateway. If the external object wants to call the functions of the internal network element, it needs to transit through the NEF to prevent direct exposure of the internal network element from causing security problems. The external object may be third parties of an operator network, the AF, an edge computing network element, etc.

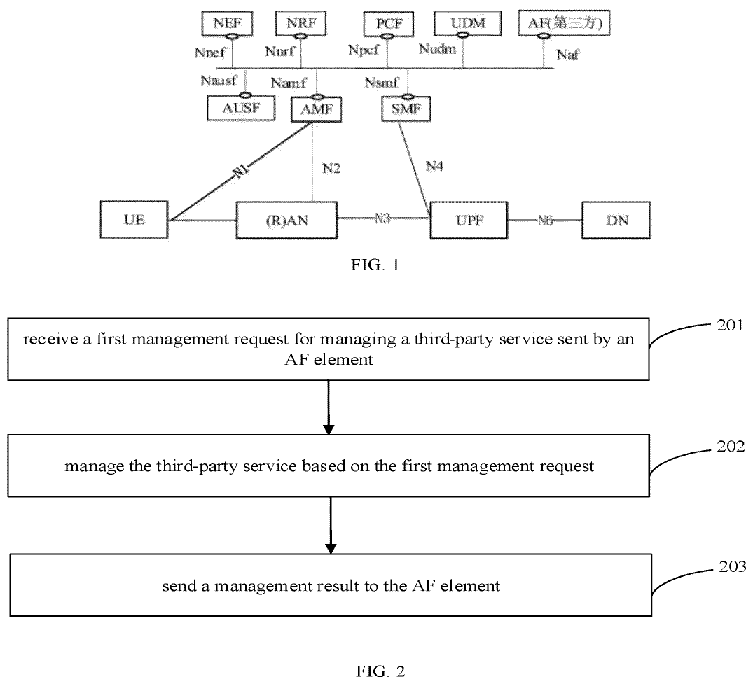

FIG. 1 is a schematic diagram of a 5G service network architecture provided by an embodiment of the disclosure. FIG. 1 shows network elements included in the 5G service network architecture and interfaces for communication between the network elements.

It is understood that the communication system in an embodiment of the disclosure is described for the purpose of more clearly illustrating the technical solution of an embodiment of the disclosure, and does not constitute a limitation on the technical solution provided by an embodiment of the disclosure. Those skilled in the art know that as system architectures evolve and new business scenarios emerge, the technical solution according to an embodiment of the disclosure is also applicable to similar technical problems.

A third-party service management method/apparatus/device and a storage medium provided by embodiments of the disclosure will be described in detail with reference to the accompanying drawings.

FIG. 2 is a flowchart of a third-party service management method provided by an embodiment of the disclosure. The method is performed by an NEF element. As illustrated in FIG. 2, the third-party service management method includes following steps.

At step 201, a first management request for managing a third-party service sent by an AF element is received.

In an embodiment of the disclosure, the first management request indicates a third-party service that can be provided by a third-party application. The third-party application may be an application other than a terminal, a network device and network elements of a network control plane. The third-party service may be, for example, a game service and a voice service provided by the third-party application.

In an embodiment of the disclosure, the first management request may be sent by the third-party application to the NEF element through the AF element.

Further, in an embodiment of the disclosure, the first management request may be a first registration request for registering the third-party service and/or a first cancellation request for cancelling the third-party service. This part will be described in detail in the following embodiments.

In addition, in an embodiment of the disclosure, the NEF element may receive the first management request for managing the third-party service sent by the AF element through a southbound interface (SBI).

At step 202, the third-party service is managed based on the first management request.

In an embodiment of the disclosure, in a case that the first management request is the first registration request, the NEF element performs registration management on the third-party service based on the first registration request. In another embodiment of the disclosure, in a case that the first management request is the first cancellation request, the NEF element performs cancellation management on the third-party service based on the first cancellation request. How to perform the registration management or cancellation management on the third-party service will be introduced in detail in the following embodiments.

At step 203, a management result is sent to the AF element.

In an embodiment of the disclosure, in a case that the first management request is the first registration request for registering the third-party service, the management result may include a registration success response or a registration failure response.

In an embodiment of the disclosure, in a case that the first management request is the first cancellation request for cancelling the third-party service, the management result may include a cancellation success response or a cancellation failure response.

In conclusion, in the third-party service management method provided by an embodiment of the disclosure, the NEF element may receive the first management request for managing the third-party service sent by the AF element. The first management request indicates the third-party service that is provided by the third-party application. The NEF element manages the third-party service based on the first management request and sends the management result to the AF element. That is, in the third-party service management method provided by the disclosure, the NEF element manages the third-party service, e.g., registering and/or cancelling the third-party service. Therefore, the NEF element may know which third-party service the third-party application can provide, and thus the network may subsequently call the third-party service through the NEF element, and richness of network services may be improved.

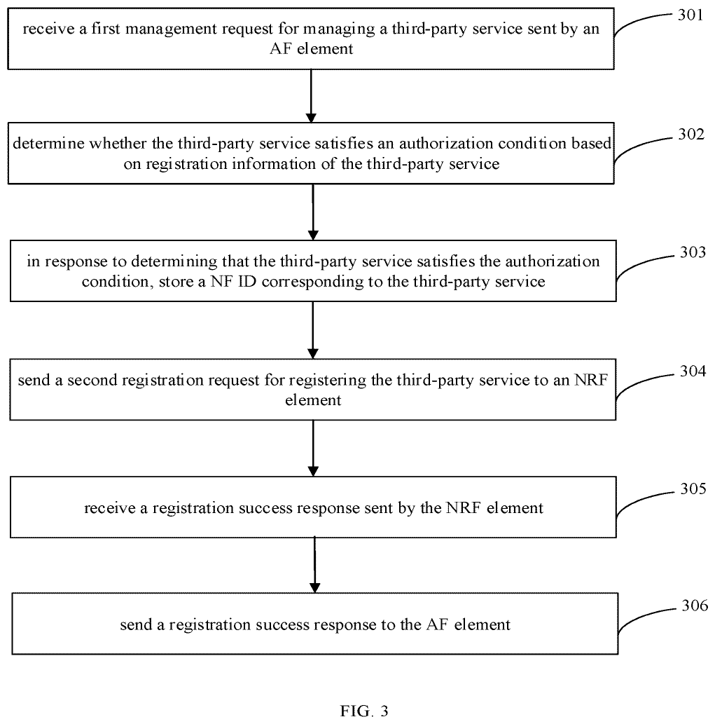

FIG. 3 is a flowchart of a third-party service management method provided by an embodiment of the disclosure. The method is performed by an NEF element. As illustrated in FIG. 3, the third-party service management method includes following steps.

At step 301, a first registration request for registering a third-party service sent by an AF element is received.

In an embodiment of the disclosure, the first registration request may be sent to the NEF element through the AF element when a third-party application needs to register the third-party service.

In an embodiment of the disclosure, the first registration request may include registration information of the third-party service for which registration is requested.

In an embodiment of the disclosure, the registration information includes at least one of:

an NF identifier (ID) corresponding to the third-party service:

an NF type corresponding to the third-party service:

an NF supported service corresponding to the third-party service: or

a public land mobile network (PLMN) ID corresponding to the third-party application.

In an embodiment of the disclosure, the NF type corresponding to the above third-party service may be an NF type to which the third-party service belongs. The NF type may include an Al service type, a perception service type, etc. For example, if the third-party service is a voice service, the NF type corresponding to the third-party service may be the AI service type.

In an embodiment of the disclosure, the NF supported service corresponding to the above third-party service may include at least one of:

a service to be executed when performing the third-party service: or

an actual execution policy when implementing the service.

For example, if the third-party service is the voice service, the NF supported service corresponding to the third-party service may include the voice service and an actual execution policy when implementing the voice service (e.g., an actual charging policy when actually implementing the voice service, etc.).

At step 302, it is determined whether the third-party service satisfies an authorization condition based on registration information of the third-party service.

In an embodiment of the disclosure, the method for the NEF element to determine whether the third-party service satisfies the authorization condition based on the registration information of the third-party service may include following steps.

At step one, it is determined whether the third-party application is eligible for registration.

In detail, in an embodiment of the disclosure, the NEF element stores a list, which includes PLMN IDs corresponding to third-party applications that have an ability to provide services to the NF element. On the basic of this, the NEF element may determine whether the list includes the PLMN ID corresponding to the third-party application in the above first registration request. In a case that the list does not include the PLMN ID in the first registration request, it represents that the third-party application corresponding to the third-party service for which registration is requested by the first registration request does not have the ability to provide the services to the NF element, and it is determined that the third-party service does not meet the authorization condition. In a case that the list includes the PLMN ID in the above first registration request, it represents that the third-party application corresponding to the third-party service for which registration is requested by the first registration request has the ability to provide the services to the NF, and then step two is further executed.

At step two, it is determined whether the third-party service is eligible for registration.

In an embodiment of the disclosure, it is possible to determine whether the third-party service is eligible for registration based on the NF type corresponding to the third-party service and the NF supported service corresponding to the third-party service in the first registration request.

Specifically, in an embodiment of the disclosure, a policy control function (PCF) distributes a standard execution policy and an admission policy corresponding to each service under each NF type to the NEF element through broadcasting. The standard execution policy is a standard execution policy defined for each service. For example, a standard execution measurement corresponding to the voice service may be, for example, a standard charging policy. The above admission policy is used to determine whether the third-party service is eligible for registration. The admission policy includes that in response to a difference between the actual execution policy corresponding to the service to be executed when performing the third-party service to be registered and the standard execution policy corresponding to the service to be executed when performing the third-party service to be registered being less than a preset threshold, it represents that the third-party service to be registered is eligible for registration. In response to the difference between the actual execution policy corresponding to the service to be executed when performing the third-party service to be registered and the standard execution policy corresponding to the service to be executed when performing the third-party service to be registered being not less than the preset threshold, it represents that the third-party service to be registered is ineligible for registration.

On the basis, in an embodiment of the disclosure, after determining the standard execution policy and the admission policy corresponding to each service, the NEF element may determine the standard execution policy corresponding to the third-party service for which registration is requested by the first registration request based on the NF type corresponding to the third-party service included in the first registration request and the service to be executed when performing the third-party service, and then determine whether the third-party service for which registration is requested by the first registration request is eligible for registration based on the standard execution policy corresponding to the third-party service for which registration is requested by the first registration request and the above admission policy. In response to determining that the third-party service for which registration is requested by the first registration request is eligible for registration, it is determined that the third-party service satisfies the authorization condition. In response to determining that the third-party service for which registration is requested by the first registration request is ineligible for registration, it is determined that the third-party service does not satisfy the authorization condition.

At step 303, an NF ID corresponding to the third-party service is stored in response to determining that the third-party service satisfies the authorization condition.

In an embodiment of the disclosure, in response to determining that the third-party service satisfies the authorization condition, the NEF element stores the NF ID corresponding to the third-party service and the PLMN ID in association, so that after the NRF element successfully registers the third-party service, the NEF element may call the third-party service based on the PLMN ID corresponding to the third-party application and the NF ID corresponding to the third-party service.

At step 304, a second registration request for registering the third-party service is sent to an NRF element.

In an embodiment of the disclosure, the second registration request may include registration information and an NEF ID.

In an embodiment of the disclosure, the NEF element may send the second registration request for registering the third-party service to the NRF element through Nnrf_NFManagement_NFRegister.

In an embodiment of the disclosure, after receiving the second registration request for registering the third-party service, the NRF element may complete the registration of the third- party service according to the registration information and the NEF ID included in the second registration request.

At step 305, a registration success response sent by the NRF element is received.

In an embodiment of the disclosure, the registration success response indicates that the registration of the third-party service at the NRF element has completed.

At step 306, a registration success response is sent to the AF element.

In an embodiment of the disclosure, the registration success response indicates that the third-party service has been registered successfully. The network device may call the third-party service subsequently, for example, calling the AF element to provide the third-party service to the NF element.

In conclusion, in the third-party service management method provided by an embodiment of the disclosure, the NEF element may receive the first management request for managing the third-party service sent by the AF element. The first management request indicates the third-party service that is provided by the third-party application. The NEF element manages the third-party service based on the first management request and sends the management result to the AF element. That is, in the third-party service management method provided by the disclosure, the NEF element manages the third-party service, e.g., registering and/or cancelling the third- party service. Therefore, the NEF element may know which third-party service the third-party application can provide, and thus the network may subsequently call the third-party service through the NEF element, and richness of network services may be improved.

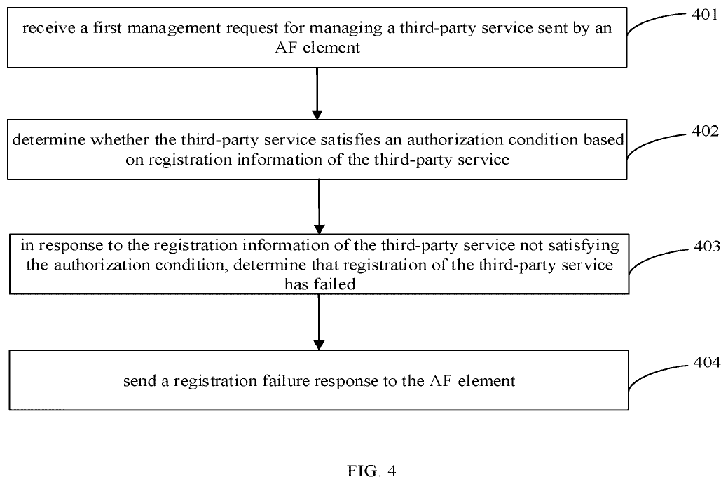

FIG. 4 is a flowchart of a third-party service management method provided by an embodiment of the disclosure. The method is performed by an NEF element. As illustrated in FIG. 4, the third-party service management method includes following steps.

At step 401, a first registration request for registering a third-party service sent by an AF element is received.

At step 402, it is determined whether the third-party service satisfies an authorization condition based on registration information of the third-party service.

The detailed descriptions of steps 401-402 are described with reference to the above embodiments, which will not be repeated in the embodiment of the disclosure.

At step 403, it is determined that registration of the third-party service has failed in response to the registration information of the third-party service not satisfying the authorization condition.

In an embodiment of the disclosure, in a case that the registration information of the third-party service does not satisfy the authorization condition, it represents that the third- party application may not be eligible for registration or the third-party service may not be eligible for registration. Therefore, the third-party service for which registration is requested by the first registration request cannot be registered at this case, therefore, it is determined that the registration of the third-party service has failed.

At step 404, a registration failure response is sent to the AF element.

In an embodiment of the disclosure, the registration failure response indicates that the third-party service has not been registered successfully.

In conclusion, in the third-party service management method provided by an embodiment of the disclosure, the NEF element may receive the first management request for managing the third-party service sent by the AF element. The first management request indicates the third-party service that is provided by the third-party application. The NEF element manages the third-party service based on the first management request and sends the management result to the AF element. That is, in the third-party service management method provided by the disclosure, the NEF element manages the third-party service, e.g., registering and/or cancelling the third-party service. Therefore, the NEF element may know which third-party service the third-party application can provide, and thus the network may subsequently call the third-party service through the NEF element, and richness of network services may be improved.

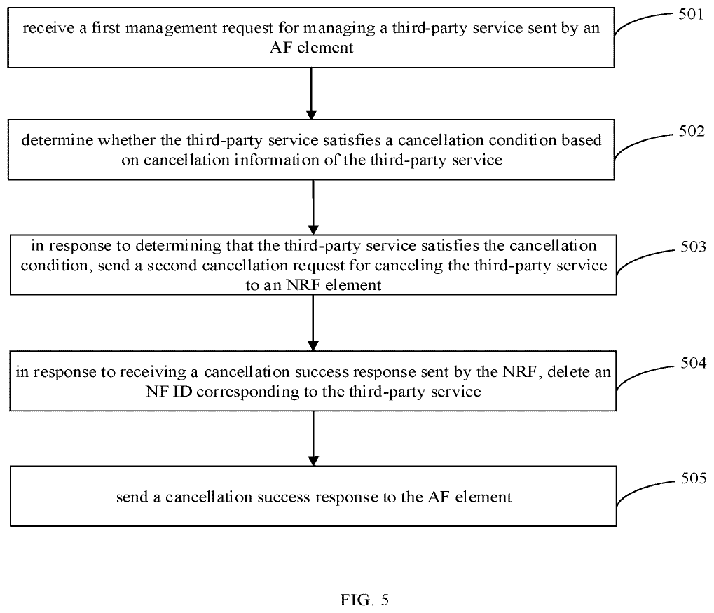

FIG. 5 is a flowchart of a third-party service management method provided by an embodiment of the disclosure. The method is performed by an NEF element. As illustrated in FIG. 5, the third-party service management method includes following steps.

At step 501, a first cancellation request for cancelling a third-party service sent by an AF element is received.

In an embodiment of the disclosure, the first cancellation request may be sent to the NEF element through the AF element when a third-party application needs to cancel the third-party service.

In an embodiment of the disclosure, the first cancellation request may include cancellation information of the third-party service for which cancellation is requested.

In an embodiment of the disclosure, the cancellation information includes at least one of:

an NF ID corresponding to the third-party service: or

a PLMN ID corresponding to the third-party application.

At step 502, it is determined whether the third-party service satisfies a cancellation condition based on cancellation information of the third-party service.

In an embodiment of the disclosure, it is determined whether the third-party service satisfies the cancellation condition based on the NF ID in the first cancellation request. In detail, the NEF element determines whether NEF element has stored the NF ID in the first cancellation request. In a case that the NEF element has stored the NF ID in the first cancellation request, it indicates that the third-party service corresponding to the NF ID has been registered and can be cancelled, and it is determined that the third-party service satisfies the cancellation condition. In a case that the NEF element has not stored the NF ID in the first cancellation request. it indicates that the third-party service corresponding to the NF ID has not been registered and the third-party service cannot be cancelled, and it is determined that the third-party service does not satisfy the cancellation condition.

In another embodiment of the disclosure, it can be determined whether the third-party service satisfies the cancellation condition based on the NF ID and the PLMN ID in the first cancellation request. Specifically, in a case that one third-party application registers a plurality of third-party services, one PLMN ID in the NEF element may be associated with a plurality of different NF IDs. One third-party service may be registered to a plurality of different third-party applications, and in this case, one NF ID in the NEF element may be associated with a plurality of different PLMN IDs. For example, a third-party application 1 and a third-party application 2 both provide a voice service, and are registered in the NEF element, therefore, PLMN ID #1 corresponding to the third-party application 1 in the NEF element is associated with the NF ID corresponding to the voice service, and PLMN ID #1 corresponding to the third-party application 2 is also associated with the NF ID corresponding to the voice service.

On the basis, in a case a certain third-party service needs to be cancelled, it should clearly determine for which third-party application the third-party service is cancelled. In response to an association relationship between the determined third-party application and the third-party service to be cancelled being absent, it represents that the third-party service to be cancelled has not been registered for this third-party application, therefore, the third-party service cannot be cancelled for the third-party application and the cancellation condition is not satisfied. In response to the association relationship between the determined third-party application and the third-party service to be cancelled being present, it represents that the third-party service to be cancelled has been registered for this third-party application, therefore, the third-party service can be cancelled for the third-party application and the cancellation condition is satisfied.

For example, suppose that PLMN ID #1 in the NEF element is associated with NF ID #1 and NF ID #2, and PLMN ID #2 is associated with NF ID #1, in a case that NF ID #2 and PLMN ID #2 are included in the first cancellation request in the above step 501, since there is no association relationship between NF ID #2 and PLMN ID #2 in the NEF element, it is determined that the third-party service does not satisfy the cancellation condition. In a case that NF ID #2 and PLMN ID #1 are included in the first cancellation request in the above step 501, since there is an association relationship between NF ID #2 and PLMN ID #1 in the NEF element, it is determined that the third-party service satisfies the cancellation condition.

At step 503, a second cancellation request for cancelling the third-party service is sent to an NRF element in response to determining that the third-party service satisfies the cancellation condition.

In an embodiment of the disclosure, the second cancellation request includes the cancellation information.

In an embodiment of the disclosure, the NEF element may send the second cancellation request for cancelling the third-party service to the NRF element through Nnrf_NFManagement_NFDeregister.

In an embodiment of the disclosure, after receiving the second cancellation request for cancelling the third-party service, the NRF element may complete cancellation of the third-party service according to the cancellation information included in the second cancellation request.

At step 504, in response to receiving a cancellation success response sent by the NRF element, an NF ID corresponding to the third-party service is deleted.

In an embodiment of the disclosure, the cancellation success response indicates that cancellation of the third-party service has been completed in the NRF element. The NEF element may delete the NF ID or delete the association relationship between the NF ID and the PLMN ID, to complete the cancellation of the third-party service in the NEF element.

At step 505, a cancellation success response is sent to the AF element.

In an embodiment of the disclosure, the registration success response indicates that the third-party service has been successfully cancelled, therefore, the network device can no longer call the third-party service.

In conclusion, in the third-party service management method provided by an embodiment of the disclosure, the NEF element may receive the first management request for managing the third-party service sent by the AF element. The first management request indicates the third-party service that is provided by the third-party application. The NEF element manages the third-party service based on the first management request and sends the management result to the AF element. That is, in the third-party service management method provided by the disclosure, the NEF element manages the third-party service, e.g., registering and/or cancelling the third-party service. Therefore, the NEF element may know which third-party service the third-party application can provide, and thus the network may subsequently call the third-party service through the NEF element, and richness of network services may be improved.

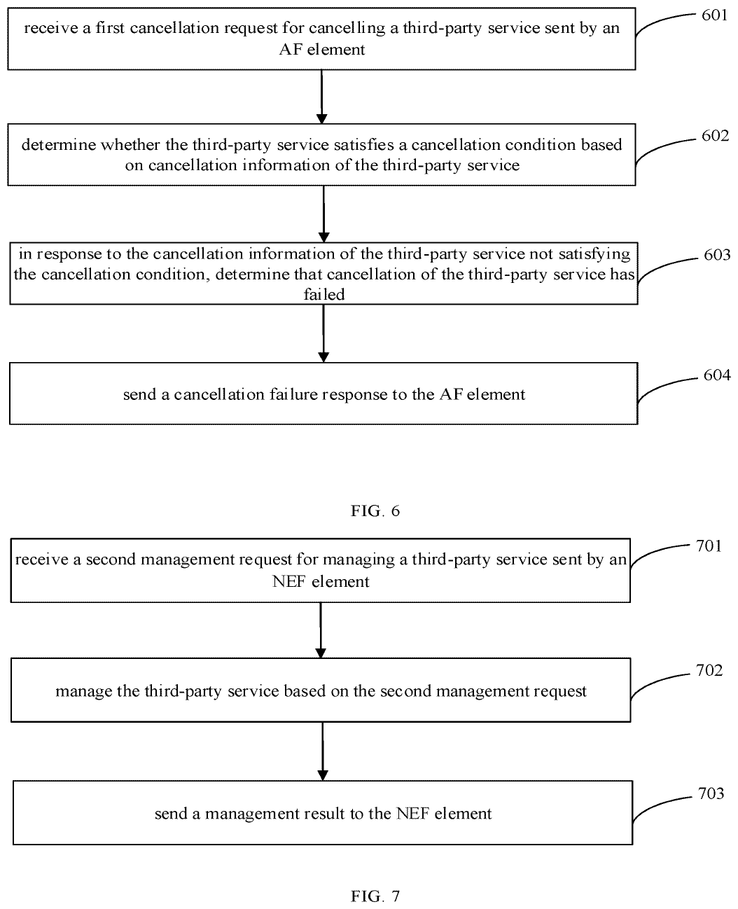

FIG. 6 is a flowchart of a third-party service management method provided by an embodiment of the disclosure. The method is performed by an NEF element. As illustrated in FIG. 6, the third-party service management method includes following steps.

At step 601, a first cancellation request for cancelling a third-party service sent by an AF element is received.

At step 602, it is determined whether the third-party service satisfies a cancellation condition based on cancellation information of the third-party service.

The detailed descriptions of steps 601-602 may be described with reference to the above embodiments, which will not be repeated in the embodiment of the disclosure.

At step 603, in response to the cancellation information of the third-party service not satisfying the cancellation condition, it is determined that cancellation of the third-party service has failed.

At step 604, a cancellation failure response is sent to the AF element.

In an embodiment of the disclosure, the cancellation failure response indicates that cancellation of the third-party service has failed.

In conclusion, in the third-party service management method provided by an embodiment of the disclosure, the NEF element may receive the first management request for managing the third-party service sent by the AF element. The first management request indicates the third-party service that is provided by the third-party application. The NEF element manages the third-party service based on the first management request and sends the management result to the AF element. That is, in the third-party service management method provided by the disclosure, the NEF element manages the third-party service, e.g., registering and/or cancelling the third-party service. Therefore, the NEF element may know which third-party service the third-party application can provide, and thus the network may subsequently call the third-party service through the NEF element, and richness of network services may be improved.

FIG. 7 is a flowchart of a third-party service management method provided by an embodiment of the disclosure. The method is performed by an NRF. As illustrated in FIG. 7, the third-party service management method includes following steps.

At step 701, a second management request for managing a third-party service sent by a NEF is received.

In an embodiment of the disclosure, the second management request indicates the third-party service provided by a third-party application.

In an embodiment of the disclosure, the third-party service may be a service (e.g., a game service, a voice service, etc.) provided by the third-party application. The third-party application may be an application other than a terminal, a network device and network elements of a network control plane.

In an embodiment of the disclosure, the second management request may be a second registration request for registering the third-party service and/or a second cancellation request for cancelling the third-party service. The detailed descriptions of the second registration request and the second cancellation request are described with reference to the above embodiments.

At step 702, the third-party service is managed based on the second management request.

In an embodiment of the disclosure, in a case that the second management request is the second registration request, the NRF element performs registration management on the third-party service based on the second registration request. In another embodiment of the disclosure, in a case that the second management request is the second cancellation request, the NRF element performs cancellation management on the third-party service based on the second cancellation request. How to perform the registration management or cancellation management on the third-party service will be introduced in detail in the following embodiments.

At step 703, a management result is sent to the NEF element.

In an embodiment of the disclosure, in a case that the second management request is the second registration request for registering the third-party service, the management result may include a registration success response.

In an embodiment of the disclosure, in a case that the second management request is the second cancellation request for cancelling the third-party service, the management result may include a cancellation success response.

In conclusion, in the third-party service management method provided by an embodiment of the disclosure, the NEF element may receive the first management request for managing the third-party service sent by the AF element. The first management request indicates the third-party service that is provided by the third-party application. The NEF element manages the third-party service based on the first management request and sends the management result to the AF element. That is, in the third-party service management method provided by the disclosure, the NEF element manages the third-party service, e.g., registering and/or cancelling the third-party service. Therefore, the NEF element may know which third-party service the third-party application can provide, and thus the network may subsequently call the third-party service through the NEF element, and richness of network services may be improved.

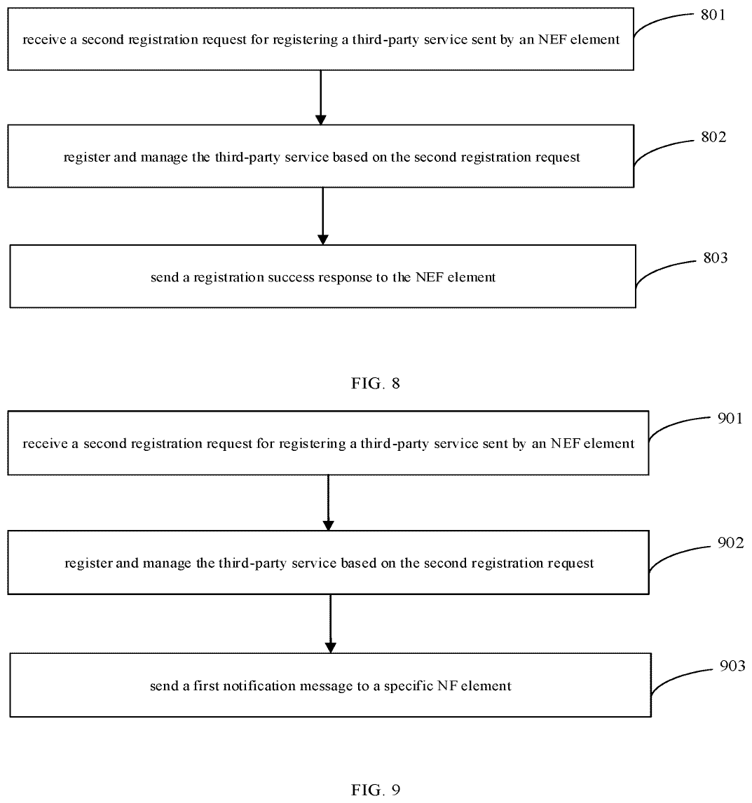

FIG. 8 is a flowchart of a third-party service management method provided by an embodiment of the disclosure. The method is performed by an NRF. As illustrated in FIG. 8, the third-party service management method includes following steps.

At step 801, a second registration request for registering a third-party service sent by an NEF element is received.

In an embodiment of the disclosure, the second registration request may include registration information of the third-party service for which registration is requested and an NEF ID.

In an embodiment of the disclosure, the registration information includes at least one of:

an NF ID corresponding to the third-party service:

an NF type corresponding to the third-party service:

an NF supported service corresponding to the third-party service: or

a PLMN ID corresponding to the third-party application.

Further, in an embodiment of the disclosure, the NRF element may receive the second registration request for registering the third-party service sent by the NEF element through Nnrf_NFManagement_NFRegister.

The detailed description of the registration information can be referred to the relevant description in the above embodiments, which will not be repeated here in the embodiment of the disclosure.

At step 802, the third-party service is registered and managed based on the second registration request.

In an embodiment of the disclosure, the method for registering and managing the third-party service based on the second registration request includes at least one of:

generating a corresponding configuration file for registering the third-party service based on registration information of the third-party service and the NEF ID: or

setting an available status corresponding to the third-party service to be as available.

It should be noted that in an embodiment of the disclosure, in a case that the corresponding registration configuration file for registering the third-party service is generated and stored based on the registration information of the third-party service and the NEF ID, it represents that registration of the third-party service has been completed in the NRF element. In a case that the NRF element sets the available status corresponding to the third-party service to be as available, it represents that registration of the third-party service has been completed in the NRF element.

In an embodiment of the disclosure, the method for setting the available status corresponding to the third-party service to be as available may include: in response to setting available status information for the third-party service, setting the available status information corresponding to the third-party service to be as a first value, in which the first value indicates that the third-party service is available. In an embodiment of the disclosure, the first value may be 1.

At step 803, a registration success response is sent to the NEF element.

The detailed descriptions of other contents in this embodiment may be referred

to the relevant descriptions in the above embodiments, which will not be repeated in the embodiment of the disclosure.

In conclusion, in the third-party service management method provided by an embodiment of the disclosure, the NEF element may receive the first management request for managing the third-party service sent by the AF element. The first management request indicates the third-party service that is provided by the third-party application. The NEF element manages the third-party service based on the first management request and sends the management result to the AF element. That is, in the third-party service management method provided by the disclosure, the NEF element manages the third-party service, e.g., registering and/or cancelling the third-party service. Therefore, the NEF element may know which third-party service the third-party application can provide, and thus the network may subsequently call the third-party service through the NEF element, and richness of network services may be improved.

FIG. 9 is a flowchart of a third-party service management method provided by an embodiment of the disclosure. The method is performed by an NRF. As illustrated in FIG. 9, the third-party service management method includes following steps.

At step 901, a second registration request for registering a third-party service sent

by an NEF element is received.

At step 902, the third-party service is registered and managed based on the second registration request.

The detailed descriptions of steps 901-902 are described with reference to the above embodiments, which will not be repeated here in the embodiment of the disclosure.

At step 903, a first notification message is sent to a specific NF element.

In an embodiment of the disclosure, the specific NF element may be a network element that has subscribed to a service change event. The service change event may include a service registration event and/or a service cancellation event. The specific NF may be specifically understood as an NF element that needs to be notified when a service change event (such as a service registration event and/or a service change event) occurs.

In an embodiment of the disclosure, the first notification message is used to notify the specific NF element that registration of the third-party service has completed. The first notification message may include a PLMD ID corresponding to the third-party application and an NF ID corresponding to the third-party service.

Further, in an embodiment of the disclosure, by sending the first notification message to the specific NF element, the specific NF element may know that registration of the third-party service indicated by the first notification message has been completed, so that the specific NF element may subsequently request to use the third-party service.

The detailed descriptions of other contents in this embodiment may be referred to the relevant descriptions in the above embodiments, which will not be repeated in the embodiment of the disclosure.

In conclusion, in the third-party service management method provided by an embodiment of the disclosure, the NEF element may receive the first management request for managing the third-party service sent by the AF element. The first management request indicates the third-party service that is provided by the third-party application. The NEF element manages the third-party service based on the first management request and sends the management result to the AF element. That is, in the third-party service management method provided by the disclosure, the NEF element manages the third-party service, e.g., registering and/or cancelling the third-party service. Therefore, the NEF element may know which third-party service the third-party application can provide, and thus the network may subsequently call the third-party service through the NEF element, and richness of network services may be improved.

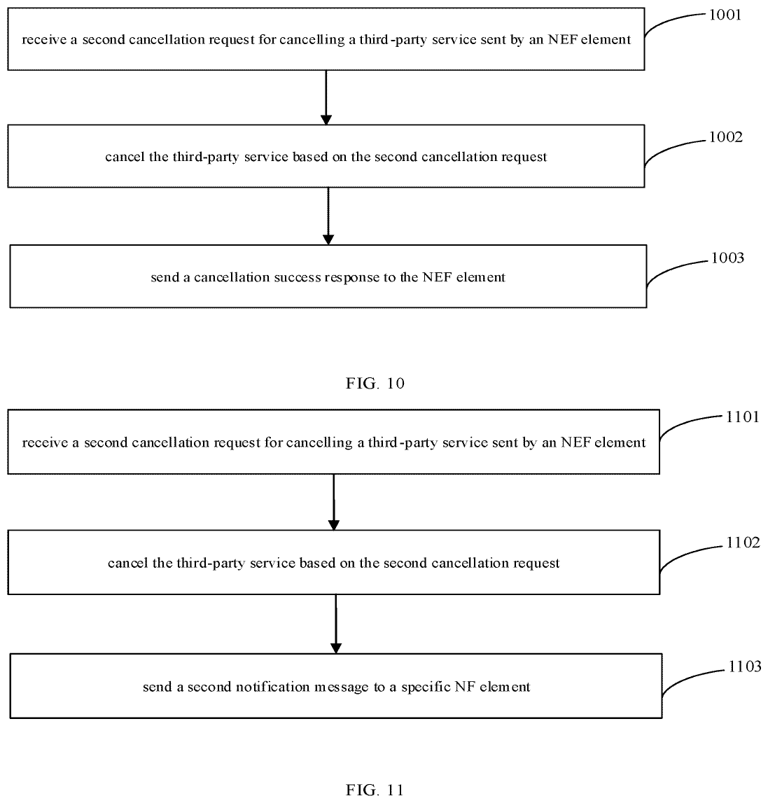

FIG. 10 is a flowchart of a third-party service management method provided by an embodiment of the disclosure. The method is performed by an NRF element. As illustrated in FIG. 10, the third-party service management method includes the following steps.

At step 1001, a second cancellation request for cancelling a third-party service sent by an NEF element is received.

In an embodiment of the disclosure, the second cancellation request may include cancellation information of the third-party service for which cancellation is requested.

In an embodiment of the disclosure, the cancellation information may include at least one of:

an NF ID corresponding to the third-party service: or

a PLMN ID corresponding to the third-party application.

In an embodiment of the disclosure, the NRF element may receive the second cancellation request for cancelling the third-party service sent by the NEF element through Nnrf_NFManagement_NFDeregister.

At step 1002, the third-party service is cancelled and managed based on the second cancellation request.

In an embodiment of the disclosure, the method for cancelling and managing the third-party service based on the second cancellation request includes at least one of:

deleting a configuration file corresponding to the third-party service based on cancellation information corresponding to the third-party service: or setting an available status of the third-party service to be as unavailable.

It should be noted that in an embodiment of the disclosure, in a case of deleting the configuration file corresponding to the third-party service based on the cancellation information of the third-party service, it represents that cancellation of the third-party service has been completed in the NRF element. In a case that the NRF element sets the available status corresponding to the third-party service to be as unavailable, it represents that cancellation of the third-party service has been completed in the NRF element.

In an embodiment of the disclosure, the method for setting the available status of the third-party service to be as unavailable includes: in response to setting available status information for the third-party service, setting the available status information corresponding to the third-party service to be as a second value, in which the second value indicates that the third- party service is unavailable. In an embodiment of the disclosure, the second value may be 0).

At step 1003, a cancellation success response is sent to the NEF element.

The detailed descriptions of other contents in this embodiment can be referred to the relevant descriptions in the above embodiments, which will not be repeated in the embodiment of the disclosure.

In conclusion, in the third-party service management method provided by an embodiment of the disclosure, the NEF element may receive the first management request for managing the third-party service sent by the AF element. The first management request indicates the third-party service that is provided by the third-party application. The NEF element manages the third-party service based on the first management request and sends the management result to the AF element. That is, in the third-party service management method provided by the disclosure, the NEF element manages the third-party service, e.g., registering and/or cancelling the third-party service. Therefore, the NEF element may know which third-party service the third-party application can provide, and thus the network may subsequently call the third-party service through the NEF element, and richness of network services may be improved.

FIG. 11 is a flowchart of a third-party service management method provided by an embodiment of the disclosure. The method is performed by an NRF element. As illustrated in FIG. 11, the third-party service management method includes the following steps.

At step 1101, a second cancellation request for cancelling a third-party service sent by an NEF element is received.

At step 1102, the third-party service is cancelled and managed based on the second cancellation request.

The detailed descriptions of steps 1101-1102 are described with reference to the above embodiments, which will not be repeated here in the embodiment of the disclosure.

At step 1103, a second notification message is sent to a specific NF element.

In an embodiment of the disclosure, the specific NF element may be a network element that has subscribed to a service change event. The service change event may include a service registration event and/or a service cancellation event. The specific NF element may be specifically understood as an NF element that needs to be notified when a service change event (such as the service registration event and/or the service change event) occurs.

In an embodiment of the disclosure, the second notification message is used to inform the specific NF element that cancellation of the third-party service has completed. The second notification message may include a PLMD ID corresponding to the third-party application and an NF ID corresponding to the third-party service.

In an embodiment of the disclosure, by sending the second notification message to the specific NF element, the specific NF may know that cancellation of the third-party service indicated by the second notification message has been completed, so that the specific NF element can no longer request to use the third-party service.

The detailed descriptions of other contents in this embodiment can be referred to the relevant descriptions in the above embodiments, which will not be repeated in the embodiment of the disclosure.

In conclusion, in the third-party service management method provided by an embodiment of the disclosure, the NEF element may receive the first management request for managing the third-party service sent by the AF element. The first management request indicates the third-party service that is provided by the third-party application. The NEF element manages the third-party service based on the first management request and sends the management result to the AF element. That is, in the third-party service management method provided by the disclosure, the NEF element manages the third-party service, e.g., registering and/or cancelling the third-party service. Therefore, the NEF element may know which third-party service the third-party application can provide, and thus the network may subsequently call the third-party service through the NEF element, and richness of network services may be improved.

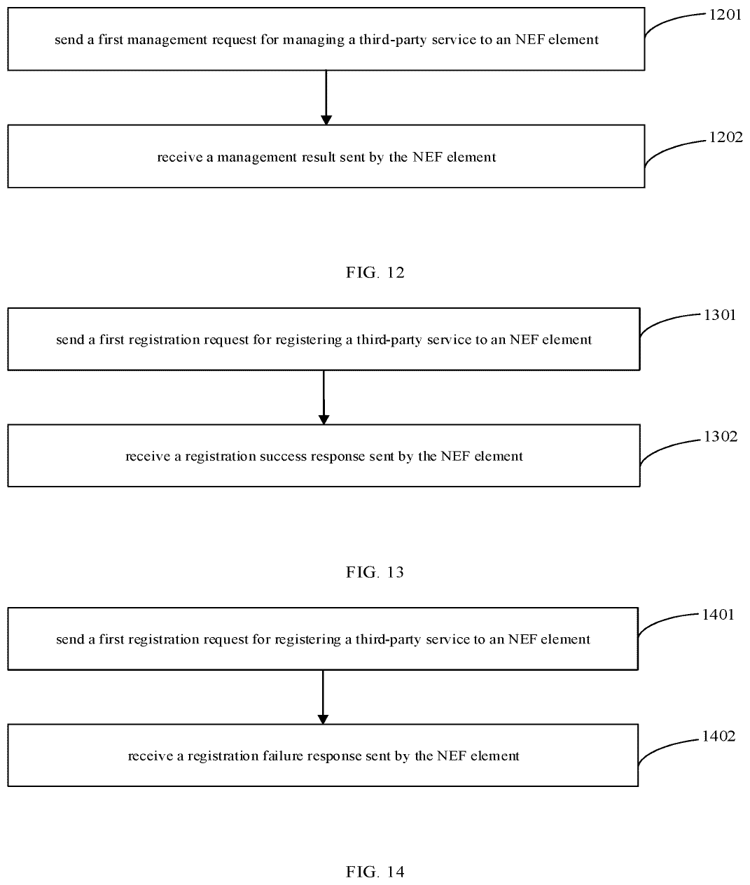

FIG. 12 is a flowchart of a third-party service management method provided by an embodiment of the disclosure. The method is performed by an AF element. As illustrated in FIG. 12, the third-party service management method includes following steps.

At step 1201, a first management request for managing a third-party service is sent to an NEF element.

In an embodiment of the disclosure, the first management request indicates the third-party service that is provided by a third-party application.

In an embodiment of the disclosure, the third-party service may be a service (e.g., a game service, a voice service, etc.) provided by the third-party application. The third-party application may be an application other than a terminal, a network device and network elements of a network control plane.

Further, in an embodiment of the disclosure, the first management request may be a first registration request for registering the third-party service and/or a first cancellation request for canceling the third-party service. This part will be described in detail in the following embodiments.

At step 1202, a management result sent by the NEF element is received.

In an embodiment of the disclosure, in a case that the first management request is the first registration request for registering a third-party service, the management result may include a registration success response or a registration failure response.

In an embodiment of the disclosure, in a case that the first management request is the first cancellation request for cancelling a third-party service, the management result may include a cancellation success response or a cancellation failure response.

In conclusion, in the third-party service management method provided by an embodiment of the disclosure, the NEF element may receive the first management request for managing the third-party service sent by the AF element. The first management request indicates the third-party service that is provided by the third-party application. The NEF element manages the third-party service based on the first management request and sends the management result to the AF element. That is, in the third-party service management method provided by the disclosure, the NEF element manages the third-party service, e.g., registering and/or cancelling the third-party service. Therefore, the NEF element may know which third-party service the third-party application can provide, and thus the network may subsequently call the third-party service through the NEF element, and richness of network services may be improved.

FIG. 13 is a flowchart of a third-party service management method provided by an embodiment of the disclosure. The method is performed by an AF element. As illustrated in FIG. 13, the third-party service management method includes following steps.

At step 1301, a first registration request for registering a third-party service is sent to an NEF element.

In an embodiment of the disclosure, the first registration request may include registration information of the third-party service.

In an embodiment of the disclosure, the registration information includes at least one of:

an NF ID corresponding to the third-party service:

an NF type corresponding to the third-party service:

an NF supported service corresponding to the third-party service: or

a PLMN ID corresponding to the third-party application.

At step 1302, a registration success response sent by the NEF element is received.

In an embodiment of the disclosure, the registration success response is used to indicate that the third-party service has been registered successfully, so that the network device may call the third-party service subsequently, for example, calling the AF element to provide the third-party service to the NF element.

The detailed descriptions of other contents in this embodiment may be referred to the relevant descriptions in the above embodiments, which will not be repeated in the embodiment of the disclosure.

In conclusion, in the third-party service management method provided by an embodiment of the disclosure, the NEF element may receive the first management request for managing the third-party service sent by the AF element. The first management request indicates the third-party service that is provided by the third-party application. The NEF element manages the third-party service based on the first management request and sends the management result to the AF element. That is, in the third-party service management method provided by the disclosure, the NEF element manages the third-party service, e.g., registering and/or cancelling the third-party service. Therefore, the NEF element may know which third-party service the third-party application can provide, and thus the network may subsequently call the third-party service through the NEF element, and richness of network services may be improved.

FIG. 14 is a flowchart of a third-party service management method provided by an embodiment of the disclosure. The method is performed by an AF element. As illustrated in FIG. 14, the third-party service management method includes following steps.

At step 1401, a first registration request for registering a third-party service is sent to an NEF element.

At step 1402, a registration failure response sent by the NEF element is received.

In an embodiment of the disclosure, the registration failure response is used to indicate that the third-party service has not been registered successfully, so that the network device cannot call the third-party service.

The detailed descriptions of other contents in this embodiment may be referred to the relevant descriptions in the above embodiments, which will not be repeated in the embodiment of the disclosure.

In conclusion, in the third-party service management method provided by an embodiment of the disclosure, the NEF element may receive the first management request for managing the third-party service sent by the AF element. The first management request indicates the third-party service that is provided by the third-party application. The NEF element manages the third-party service based on the first management request and sends the management result to the AF element. That is, in the third-party service management method provided by the disclosure, the NEF element manages the third-party service, e.g., registering and/or cancelling the third- party service. Therefore, the NEF element may know which third-party service the third-party application can provide, and thus the network may subsequently call the third-party service through the NEF element, and richness of network services may be improved.

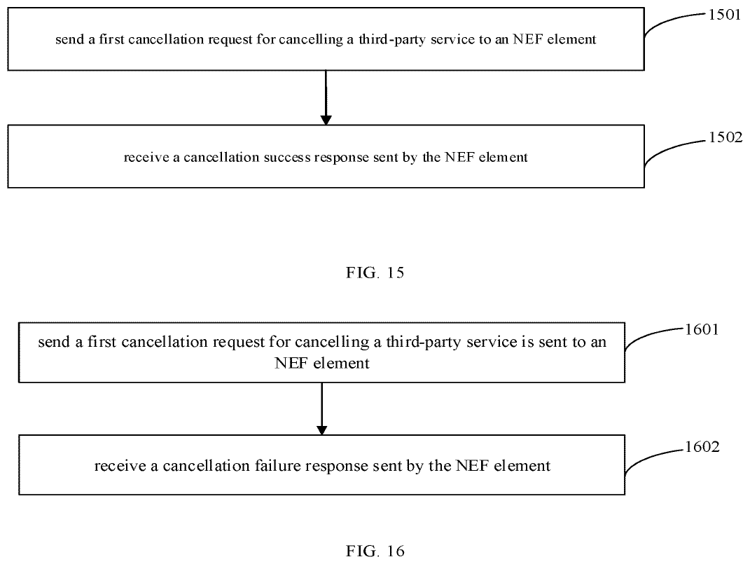

FIG. 15 is a flowchart of a third-party service management method provided by an embodiment of the disclosure. The method is performed by an AF element. As illustrated in FIG. 15, the third-party service management method includes following steps.

At step 1501, a first cancellation request for cancelling a third-party service is sent to an NEF element.

In an embodiment of the disclosure, the first cancellation request includes cancellation information of the third-party service.

In an embodiment of the disclosure, the cancellation information may include at least one of:

an NF ID corresponding to the third-party service: or

a PLMN ID corresponding to the third-party application.

The detailed descriptions of other contents in this embodiment may be referred to the relevant descriptions in the above embodiments, which will not be repeated in the embodiment of the disclosure.

At step 1502, a cancellation success response sent by the NEF element is received.

In an embodiment of the disclosure, the cancellation success response is used to indicate that the third-party service has been successfully cancelled, so that the network device can no longer call the third-party service.

The detailed descriptions of other contents in this embodiment may be referred to the relevant descriptions in the above embodiments, which will not be repeated in the embodiment of the disclosure.

In conclusion, in the third-party service management method provided by an embodiment of the disclosure, the NEF element may receive the first management request for managing the third-party service sent by the AF element. The first management request indicates the third-party service that is provided by the third-party application. The NEF element manages the third-party service based on the first management request and sends the management result to the AF element. That is, in the third-party service management method provided by the disclosure, the NEF element manages the third-party service, e.g., registering and/or cancelling the third-party service. Therefore, the NEF element may know which third-party service the third-party application can provide, and thus the network may subsequently call the third-party service through the NEF element, and richness of network services may be improved.

FIG. 16 is a flowchart of a third-party service management method provided by an embodiment of the disclosure. The method is performed by an AF element. As illustrated in FIG. 16, the third-party service management method includes the following steps.

At step 1601, a first cancellation request for cancelling a third-party service is sent to an NEF element.

At step 1602, a cancellation failure response sent by the NEF element is received.

In an embodiment of the disclosure, in a case that the AF element receives the cancellation failure response sent by the NEF element, it represents that cancellation of the third- party service has failed.

The detailed descriptions of other contents in this embodiment may be referred to the relevant descriptions in the above embodiments, which will not be repeated in the embodiment of the disclosure.

In conclusion, in the third-party service management method provided by an embodiment of the disclosure, the NEF element may receive the first management request for managing the third-party service sent by the AF element. The first management request indicates the third-party service that is provided by the third-party application. The NEF element manages the third-party service based on the first management request and sends the management result to the AF element. That is, in the third-party service management method provided by the disclosure, the NEF element manages the third-party service, e.g., registering and/or cancelling the third-party service. Therefore, the NEF element may know which third-party service the third-party application can provide, and thus the network may subsequently call the third-party service through the NEF element, and richness of network services may be improved.

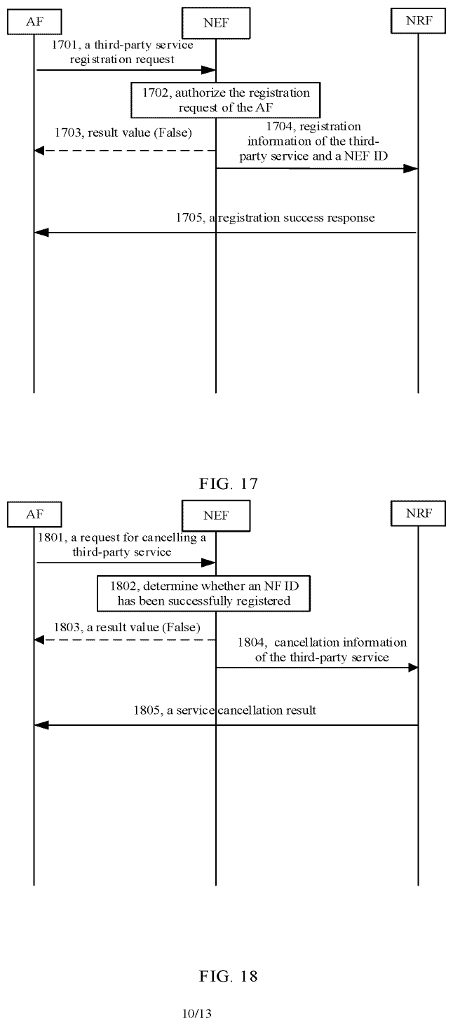

Based on the above description, FIG. 17 illustrates an interaction method of third-party service registration according to an embodiment of the disclosure. As illustrated in FIG. 17, the method may include following steps.

At step 1701, an AF element sends a new registration request of a third-party service (i.e., the first registration request in the above embodiment) to an NEF element, to perform a service registration process in a core network.

At step 1702, the NEF element authorizes the registration request of the AF element. In a case that authorization is successfully, the NEF element stores an NF ID corresponding to the third-party service, and performs steps 1704-1705. In a case that the authorization has failed, it executes step 1703.

At step 1703, the NEF element sends a result value (False, i.e., the registration failure response in the above embodiment) to the AF element, which indicates that the authorization has failed, and the process has ended.

At step 1704, the NEF element sends registration information of the third-party service and an NEF ID to the NRF element through Nnrf_NFManagement_NFRegister (e.g., carrying the registration information of the third-party service and the NEF ID in the second registration request and sending the second registration request to the NRF element).

At step 1705, the NRF element generates a corresponding configuration file for registering the third-party service based on the registration information of the third-party service and the NEF ID and sets an available status corresponding to the third-party service to be as available, and notifies all other NF elements that have subscribed to a service change event, e.g., sending a first notification message to all the other NF element s (not shown in this step in FIG. 17), and then sends a registration success response to the AF element through the NEF element.

Based on the above description, FIG. 18 illustrates an interaction method of third-party service registration according to an embodiment of the disclosure. As illustrated in FIG. 18, the method may include following steps.

At step 1801, an AF element sends a request cancellation of a third-party service to an NEF element (i.e., the first cancellation request in the above embodiment), to perform a service registration process in a core network.

At step 1802, the NEF element determines whether an NF ID has been successfully registered according to the NF ID in the received cancellation request, and in a case that the NF ID has not been found, it represents that the third-party service has not been successfully registered, and the NEF element executes step 1803. In a case that the NF ID has been found, it represents that the third-party service has been successfully registered, the NEF element executes steps 1804-1805.

At step 1803, the NEF element sends a result value (False, i.e., the cancellation failure response in the above embodiment) to the AF element, which indicates that cancellation has failed, and the process has ended.

At step 1804, the NEF element sends cancellation information of the third-party service to the NRF element through Nnrf_NFManagement_NFDeregister (for example, carrying the cancellation information of the third-party service in the above second cancellation request and sending the second cancellation request to the NRF element).

At step 1805, the NRF element deletes a configuration file corresponding to the third-party service based on the cancellation information corresponding to the third-party service and sets an available status of the third-party service to be as unavailable, and notifies all other NF elements that have subscribed to a service change event, e.g., sending a second notification message to all the other NF elements (this step is not shown in FIG. 18), and sends a cancellation success response to the AF element through the NEF element.

In the above-mentioned embodiments of the disclosure, the methods in the embodiments of the disclosure are introduced from the perspectives of the network device and the user equipment (UE) respectively. In order to realize the functions in the methods of the embodiments of the disclosure, the network device and the UE may include a hardware structure and a software module, and realize the above functions in the form of the hardware structure, the software module, or a combination of the hardware structure and the software module. A certain function of the above functions can be implemented in a hardware structure, a software module, or a combination of the hardware structure and the software module.

FIG. 19 is a schematic diagram of a communication device provided by an embodiment of the disclosure. As illustrated in FIG. 19, the communication device includes:

a transceiver module 1901, configured to receive a first management request for managing a third-party service sent by an AF element, in which the first management request indicates the third-party service that is provided by a third-party application:

a managing module 1902, configured to manage the third-party service based on the first management request: and

the transceiver module 1901, further configured to send a management result to the AF element.

In conclusion, in the communication device provided by the embodiment of the disclosure, the NEF element may receive the first management request for managing the third-party service sent by the AF element. The first management request indicates the third-party service that is provided by the third-party application. The NEF element manages the third-party service based on the first management request and sends the management result to the AF element. That is, in the third-party service management method provided by the disclosure, the NEF element manages the third-party service, e.g., registering and/or cancelling the third-party service. Therefore, the NEF element may know which third-party service the third-party application can provide, and thus the network may subsequently call the third-party service through the NEF element, and richness of network services may be improved.

Optionally, in an embodiment of the disclosure, the transceiver module 1901 is further configured to:

receive a first registration request for registering the third-party service sent by the AF element, in which the first registration request includes registration information of the third-party service.

The registration information includes at least one of:

an NF ID corresponding to the third-party service:

an NF type corresponding to the third-party service:

an NF supported service corresponding to the third-party service: or

a PLMN ID corresponding to the third-party application.

Optionally, in an embodiment of the disclosure, the managing module 1902 is further configured to:

determine whether the third-party service satisfies an authorization condition based on the registration information of the third-party service:

store an NF ID corresponding to the third-party service in response to determining that the third-party service satisfies the authorization condition:

send a second registration request for registering the third-party service to an NRF element, in which the second registration request includes the registration information and an NEF ID: and

receive a registration success response sent by the NRF element.

Optionally, in an embodiment of the disclosure, the transceiver module 1901 is further configured to:

send a registration success response to the AF element.

Optionally, in an embodiment of the disclosure, the managing module 1902 is further configured to:

determine whether the third-party service satisfies an authorization condition based on the registration information of the third-party service; and

determine that registration of the third-party service has failed in response to the registration information of the third-party service not satisfying the authorization condition.

Optionally, in an embodiment of the disclosure, the transceiver module 1901 is further configured to:

send a registration failure response to the AF element.

Optionally, in an embodiment of the disclosure, the transceiver module 1901 is further configured to:

receive a first cancellation request for cancelling the third-party service sent by the AF element, in which the first cancellation request includes cancellation information of the third-party service.

The cancellation information may include at least one of:

an NF ID corresponding to the third-party service: or

a PLMN ID corresponding to the third-party application.

Optionally, in an embodiment of the disclosure, the managing module 1902 is further configured to:

determine whether the third-party service satisfies a cancellation condition based on the cancellation information of the third-party service:

send a second cancellation request for cancelling the third-party service to an NRF element in response to determining that the third-party service satisfies the cancellation condition, in which the second cancellation request includes the cancellation information: and

delete an NF ID corresponding to the third-party service in response to receiving a cancellation success response sent by the NRF element.

Optionally, in an embodiment of the disclosure, the transceiver module 1901 is further configured to:

send a cancellation success response to the AF element.

Optionally, in an embodiment of the disclosure, the transceiver module 1901 is further configured to:

determine whether the third-party service satisfies a cancellation condition based on the cancellation information of the third-party service: and

determine that cancellation of the third-party service has failed in response to the cancellation information of the third-party service not satisfying the cancellation condition.

Optionally, in an embodiment of the disclosure, the transceiver module 1901 is further configured to:

send a cancellation failure response to the AF element.

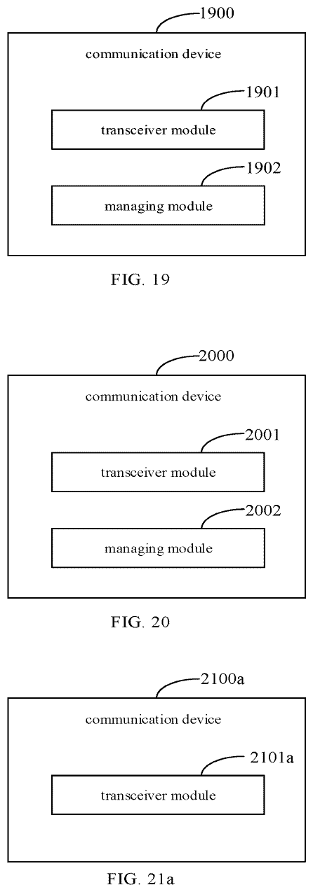

FIG. 20 is a schematic diagram of a communication device provided by an embodiment of the disclosure. As illustrated in FIG. 20, the communication device includes:

a transceiver module 2001, configured to receive a second management request for managing a third-party service sent by an NEF element, in which the second management request indicates the third-party service that is provided by a third-party application:

a managing module 2002, configured to manage the third-party service based on the second management request: and

the transceiver module 2001, further configured to send a management result to the NEF element.

In conclusion, in the communication device provided by the embodiment of the disclosure, the NEF element may receive the first management request for managing the third-party service sent by the AF element. The first management request indicates the third-party service that is provided by the third-party application. The NEF element manages the third-party service based on the first management request and sends the management result to the AF element. That is, in the third-party service management method provided by the disclosure, the NEF element manages the third-party service, e.g., registering and/or cancelling the third-party service. Therefore, the NEF element may know which third-party service the third-party application can provide, and thus the network may subsequently call the third-party service through the NEF element, and richness of network services may be improved.

Optionally, in an embodiment of the disclosure, the transceiver module 2001 is further configured to:

receive a second registration request for registering the third-party service sent by the NEF element, in which the second registration request includes registration information of the third-party service and an NEF ID.

The registration information includes at least one of:

an NF ID corresponding to the third-party service:

an NF type corresponding to the third-party service:

an NF supported service corresponding to the third-party service: or

a PLMN ID corresponding to the third-party application.

Optionally, in an embodiment of the disclosure, the managing module 2002 is further configured to:

generate a configuration file for registering the third-party service based on the registration information of the third-party service and the NEF ID: or

set an available status corresponding to the third-party service to be as available.

Optionally, in an embodiment of the disclosure, the transceiver module 2001 is further configured to:

send a registration success response to the NEF element.

Optionally, in an embodiment of the disclosure, the device is further configured to:

send a first notification message to a specific NF element, in which the specific NF element is a network element that has subscribed to a service change event, and the first notification message indicates that registration of the third-party service has completed.

Optionally, in an embodiment of the disclosure, the transceiver module 2001 is further configured to:

receive a second cancellation request for cancelling the third-party service sent by the NEF element, in which the second cancellation request includes cancellation information of the third-party service.

The cancellation information may include at least one of:

an NF ID corresponding to the third-party service; or

a PLMN ID corresponding to the third-party application.

Optionally, in an embodiment of the disclosure, the managing module 2002 is further configured to:

delete a configuration file corresponding to the third-party service based on the cancellation information corresponding to the third-party service: or set an available status of the third-party service to be as unavailable.

Optionally, in an embodiment of the disclosure, the transceiver module 2001 is further configured to:

send a cancellation success response to the NEF element.

Optionally, in an embodiment of the disclosure, the device is further configured to:

send a second notification message to a specific NF element, in which the specific NF element is a network element that has subscribed to a service change event, and the second notification message indicates that cancellation of the third-party service has completed.

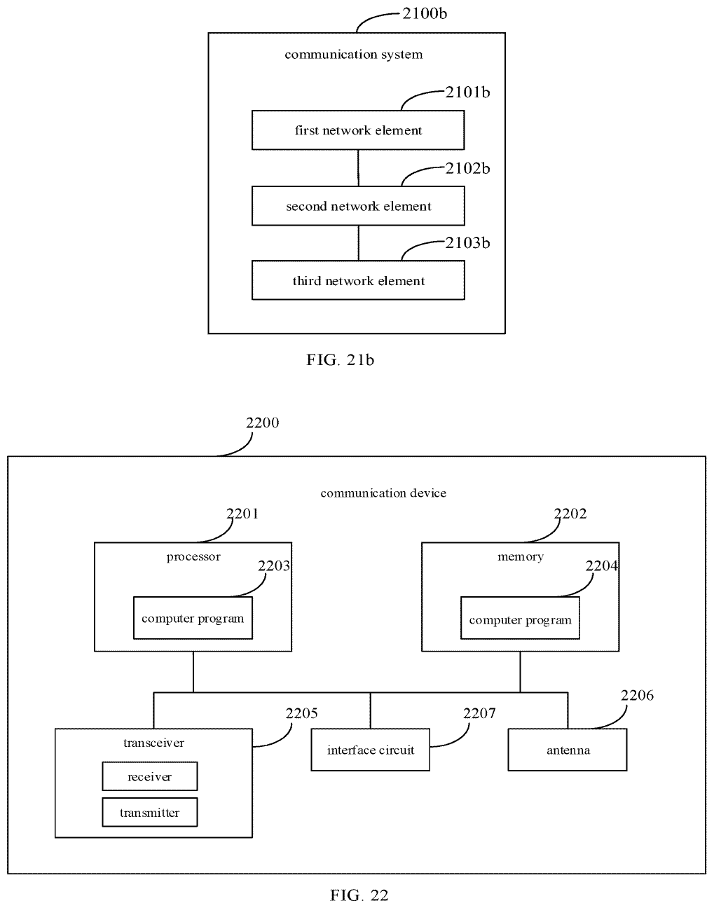

FIG. 21a is a schematic diagram of a communication device provided by an embodiment of the disclosure. As illustrated in FIG. 21a, the communication device includes:

a transceiver module 2101a, configured to send a first management request for managing a third-party service to an NEF element, in which the first management request indicates the third-party service that is provided by a third-party application: and

the transceiver module 2101a, further configured to receive a management result sent by the NEF element.

In conclusion, in the communication device provided by the embodiment of the disclosure, the NEF element may receive the first management request for managing the third-party service sent by the AF element. The first management request indicates the third-party service that is provided by the third-party application. The NEF element manages the third-party service based on the first management request and sends the management result to the AF element. That is, in the third-party service management method provided by the disclosure, the NEF element manages the third-party service, e.g., registering and/or cancelling the third-party service. Therefore, the NEF element may know which third-party service the third-party application can provide, and thus the network may subsequently call the third-party service through the NEF element, and richness of network services may be improved.

Optionally, in an embodiment of the disclosure, the transceiver module 2101a is further configured to:

send a first registration request for registering the third-party service to the NEF element, in which the first registration request includes registration information of the third-party service.

The registration information includes at least one of:

an NF ID corresponding to the third-party service:

an NF type corresponding to the third-party service:

an NF supported service corresponding to the third-party service: or

a PLMN ID corresponding to the third-party application.

Optionally, in an embodiment of the disclosure, the transceiver module 2101a is further configured to:

receive a registration success response sent by the NEF element.

Optionally, in an embodiment of the disclosure, the transceiver module 2101a is

further configured to:

receive a registration failure response sent by the NEF element.

Optionally, in an embodiment of the disclosure, the transceiver module 2101a is further configured to:

send a first cancellation request for cancelling the third-party service to the NEF element, in which the first cancellation request includes cancellation information of the third- party service.

The cancellation information may include at least one of:

an NF ID corresponding to the third-party service: or

a PLMN ID corresponding to the third-party application.

Optionally, in an embodiment of the disclosure, the transceiver module 2101a is further configured to:

receive a cancellation success response sent by the NEF element.

Optionally, in an embodiment of the disclosure, the transceiver module 2101a is further configured to:

receive a cancellation failure response sent by the NEF element.

FIG. 21b is a schematic diagram of a communication device provided by an embodiment of the disclosure. As illustrated in FIG. 21b, the communication device includes:

a first network element (i.e., the AF element in the above embodiment) 2101b, configured to send a first management request for managing a third-party service, in which the first management request indicates the third-party service that is provided by a third-party application:

a second network element (i.e., the NEF element in the above embodiment) 2102b, configured to receive the first management request for managing the third-party service and manage the third-party service based on the first management request:

the second network element 2102b, further configured to send a second management request for managing the third-party service, in which the second management request indicates the third-party service that is provided by the third-party application:

a third network element (i.e., the NRF element in the above embodiment) 2103b, configured to receive the second management request for managing the third-party service and manage the third-party service based on the second management request, and send a management result to the second network element:

the second network element 2102b, further configured to send the management result to the first network element: and

the first network element 2101b, further configured to receive the management result sent by the second network element.

In an embodiment of the disclosure, the first network element, the second network element and the third network element may communicate with each other.

The detailed descriptions of other contents in this embodiment may be referred to the relevant descriptions in the above embodiments, which will not be repeated in the embodiment of the disclosure.

In conclusion, in the communication system provided by the embodiment of the disclosure, the NEF element may receive the first management request for managing the third-party service sent by the AF element. The first management request indicates the third-party service that is provided by the third-party application. The NEF element manages the third-party service based on the first management request and sends the management result to the AF element. That is, in the third-party service management method provided by the disclosure, the NEF element manages the third-party service, e.g., registering and/or cancelling the third-party service. Therefore, the NEF element may know which third-party service the third-party application can provide, and thus the network may subsequently call the third-party service through the NEF element, and richness of network services may be improved.

Optionally, the above communication system can be used to register a third-party service. The system includes:

a first network element, configured to send a first registration request for registering a third-party service, in which the first management request indicates the third-party service that is provided by a third-party application:

a second network element, configured to receive the first registration request for registering the third-party service, and register and manage the third-party service based on the first registration request:

the second network element, further configured to send a second registration request for registering the third-party service, in which the second management request indicates the third-party service that is provided by the third-party application:

a third network element, configured to receive the second registration request for registering the third-party service, and register and manage the third-party service based on the second registration request, and send a registration success response to the second network element:

the second network element, further configured to send a registration success response or a registration failure response to the first network element: and

the first network element, further configured to receive the registration success response or the registration failure response sent by the second network element.

Optionally, the above communication system can be used to cancel the third-party service. The system includes:

the first network element, configured to send a first cancellation request for cancelling the third-party service, in which the first cancellation request indicates the third-party service that is provided by the third-party application:

the second network element, configured to receive the first cancellation request for cancelling the third-party service and cancel the third-party service based on the first cancellation request:

the second network element, further configured to send a second cancellation request for cancelling a third-party service, in which the second cancellation request indicates the third-party service that is provided by a third-party application:

the third network element, configured to receive the second cancellation request for cancelling the third-party service, cancel the third-party service based on the second cancellation request, and send a cancellation success response to the second network element:

the second network element, further configured to send a cancellation success response or a cancellation failure response to the first network element:

the first network element is further configured to receive the cancellation success response or the cancellation failure response sent by the second network element.

Optionally, in an embodiment of the disclosure, the second network element 2102b is further configured to:

receive a first registration request for registering the third-party service sent by a first network element, in which the first registration request includes registration information of the third-party service.

The registration information includes at least one of:

an NF ID corresponding to the third-party service:

an NF type corresponding to the third-party service:

an NF supported service corresponding to the third-party service: or

a PLMN ID corresponding to the third-party application.

Optionally, in an embodiment of the disclosure, the second network element 2102b is further configured to:

determine whether the third-party service satisfies an authorization condition based on the registration information of the third-party service:

in response to determining that the third-party service satisfies the authorization condition, store an NF ID corresponding to the third-party service:

send a second registration request for registering the third-party service to a third network element, in which the second registration request includes the registration information and a second network element ID: and receive a registration success response sent by the third network element.

Optionally, in an embodiment of the disclosure, the second network element 2102b is further configured to:

send a registration success response to the first network element.

Optionally, in an embodiment of the disclosure, the second network element 2102b is further configured to:

determine whether the third-party service satisfies an authorization condition based on the registration information of the third-party service: and

in response to the registration information of the third-party service not satisfying the authorization condition, determine that registration of the third-party service has failed.

Optionally, in an embodiment of the disclosure, the second network element 2102b is further configured to:

send a registration failure response to the first network element.

Optionally, in an embodiment of the disclosure, the second network element 2102b is further configured to:

receive a first cancellation request for cancelling the third-party service sent by the first network element, in which the first cancellation request includes cancellation information of the third-party service.

The cancellation information may include at least one of:

an NF ID corresponding to the third-party service: or

a PLMN ID corresponding to the third-party application.

Optionally, in an embodiment of the disclosure, the second network element 2102b is further configured to:

determine whether the third-party service satisfies a cancellation condition based on the cancellation information of the third-party service:

in response to determining that the third-party service satisfies the cancellation condition, send a second cancellation request for cancelling the third-party service to a third network element, in which the second cancellation request includes the cancellation information: and

in response to receiving a cancellation success response sent by the third network element, delete an NF ID corresponding to the third-party service.

Optionally, in an embodiment of the disclosure, the second network element 2102b is further configured to:

send a cancellation success response to the first network element.

Optionally, in an embodiment of the disclosure, the second network element 2102b is further configured to:

determine whether the third-party service satisfies a cancellation condition based on the cancellation information of the third-party service; and

in response to the cancellation information of the third-party service not satisfying the cancellation condition, determine that cancellation of the third-party service has failed.

Optionally, in an embodiment of the disclosure, the second network element 2102b is further configured to:

send a cancellation failure response to the first network element.

Optionally, in an embodiment of the disclosure, the third network element 2103b is further configured to:

receive a second registration request for registering the third-party service sent by a second network element, in which the second registration request includes registration information of the third-party service and a second network element ID.

The registration information includes at least one of:

an NF ID corresponding to the third-party service:

an NF type corresponding to the third-party service:

an NF supported service corresponding to the third-party service: or

a PLMN ID corresponding to the third-party application.

Optionally, in an embodiment of the disclosure, the third network element 2103b is further configured to:

generate a configuration file for registering the third-party service based on the registration information of the third-party service and the second network element ID: and

set an available status corresponding to the third-party service to be as available.

Optionally, in an embodiment of the disclosure, the third network element 2103b is further configured to:

send a registration success response to the second network element.

Optionally, in an embodiment of the disclosure, the third network element 2103b is further configured to:

send a first notification message to a specific NF element, in which the specific NF element is a network element that has subscribed to a service change event, and the first notification message is used to indicate that registration of the third-party service has completed.

Optionally, in an embodiment of the disclosure, the third network element 2103b is further configured to:

receive a second cancellation request for cancelling the third-party service sent by the NEF element, in which the second cancellation request includes cancellation information of the third-party service.

The cancellation information may include at least one of:

an NF ID corresponding to the third-party service: or

a PLMN ID corresponding to the third-party application.

Optionally, in an embodiment of the disclosure, the third network element 2103b is further configured to:

delete a configuration file corresponding to the third-party service based on the cancellation information corresponding to the third-party service: or

set an available status of the third-party service to be as unavailable.

Optionally, in an embodiment of the disclosure, the third network element 2103b is further configured to:

send a cancellation success response to the second network element.

Optionally, in an embodiment of the disclosure, the third network element 2103b is further configured to:

send a second notification message to a specific NF element, in which the specific NF element is a network element that has subscribed to a service change event, and the second notification message is used to indicate that cancellation of the third-party service has completed.

Optionally, in an embodiment of the disclosure, the first network element 2101b is further configured to:

send a first registration request for registering the third-party service to the second network element, in which the first registration request includes registration information of the third-party service.

The registration information includes at least one of:

an NF ID corresponding to the third-party service:

an NF type corresponding to the third-party service:

an NF supported service corresponding to the third-party service: or

a PLMN ID corresponding to the third-party application.

Optionally, in an embodiment of the disclosure, the first network element 2101b is further configured to:

receive a registration success response sent by the second network element.

Optionally, in an embodiment of the disclosure, the first network element 2101b is further configured to:

receive a registration failure response sent by the second network element.

Optionally, in an embodiment of the disclosure, the first network element 2101b is further configured to:

send a first cancellation request for cancelling the third-party service to the second network element, in which the first cancellation request includes cancellation information of the third-party service.

The cancellation information may include at least one of:

an NF ID corresponding to the third-party service: or

a PLMN ID corresponding to the third-party application.

Optionally, in an embodiment of the disclosure, the first network element 2101b is further configured to:

receive a cancellation success response sent by the second network element.

Optionally, in an embodiment of the disclosure, the first network element 2101b is further configured to:

receive a cancellation failure response sent by the second network element.

As illustrated in FIG. 22, FIG. 22 is a schematic diagram of a communication device 2200 provided by an embodiment of the disclosure. The communication device 2200 may be a terminal or a network device, or may be a chip, a chip system or a processor that supports the terminal to realize the above-described methods, or may be a chip, a chip system or a processor that supports the network device to realize the above-described methods. The device may be used to realize the methods described in the above method embodiments with reference to the description of the above-described method embodiments.

The communication device 2200 may include one or more processors 2201. The processor 2201 may be a general purpose processor or a dedicated processor, such as, a baseband processor and a central processor. The baseband processor is used for processing communication protocols and communication data. The central processor is used for controlling the communication device (e.g., a base station, a baseband chip, a terminal, a terminal chip, a central unit (CU), or a distributed unit (DU)), executing computer programs, and processing data of the computer programs.

Optionally, the communication device 2200 may include one or more memories 2202 on which computer programs 2204 may be stored. The processor 2201 executes the computer programs 2204 to cause the communication device 2200 to perform the methods described in the above method embodiments. Optionally, the memory 2202 may also store data. The communication device 2200 and the memory 2202 may be provided separately or may be integrated together.

Optionally, the communication device 2200 may also include a transceiver 2205 and an antenna 2206. The transceiver 2205 may be referred to as a transceiver unit, a transceiver machine, or a transceiver circuit, for realizing a transceiver function. The transceiver 2205 may include a receiver and a transmitter. The receiver may be referred to as a receiving machine or a receiving circuit, for realizing the receiving function. The transmitter may be referred to as a transmitter machine or a transmitting circuit, for realizing the transmitting function.

Optionally, the communication device 2200 may also include one or more interface circuits 2207. The interface circuits 2207 are used to receive code instructions and transmit the code instructions to the processor 2201. The processor 2201 runs the code instructions to cause the communication device 2200 to perform the methods described in the method embodiments.

If the communication device 2200 is an NEF element, the transceiver 2205 executes steps 201 and 203 in FIG. 2: step 301, and steps 304-306 in FIG. 3: steps 401 and 404 in FIG. 4: step 501, and steps 503-505 in FIG. 5: and steps 601 and 604 in FIG. 6. The processor 2201 executes step 202 in FIG. 2: steps 302-303 in FIG. 3: steps 402-403 in FIG. 4: step 502 in FIG. 5: and steps 602-603 in FIG. 6.

If the communication device 2200 is an NRF element, the transceiver 2205 executes steps 701 and 703 in FIG. 7: steps 801 and 803 in FIG. 8: steps 901 and 903 in FIG. 9: steps 1001 and 1003 in FIG. 10: steps 1101 and 1103 in FIG. 11. The processor 2201 executes step 702 in FIG. 7: step 802 in FIG. 8: step 902 in FIG. 9: step 1002 in FIG. 10; and step 1102 in FIG. 11.

If the communication device 2200 is an AF element, the transceiver 2205 executes steps 1201-1202 in FIG. 12: steps 1301-1302 in FIG. 13: steps 1401-1402 in FIG. 14: steps 1501-1502 in FIG. 15: and steps 1601-1602 in FIG. 16. The processor 2201 executes step 504 in FIG. 5.

In an implementation, the processor 2201 may include a transceiver for implementing the receiving and sending functions. The transceiver may be, for example, a transceiver circuit, an interface, or an interface circuit. The transceiver circuit, the interface, or the interface circuit for implementing the receiving and sending functions may be separated or may be integrated together. The transceiver circuit, the interface, or the interface circuit described above may be used for reading and writing code/data, or may be used for signal transmission or delivery.

In an implementation, the memory 2202 may store a computer program 2203. When the computer program 2203 runs on the processor 2201, the communication device 2200 is caused to perform the methods described in the method embodiments above. The computer program 2203 may be solidified in the processor 2201, and in such case the processor 2201 may be implemented by hardware.

In an implementation, the communication device 2200 may include circuits. The circuits may implement the sending, receiving or communicating function in the preceding method embodiments. The processor and the transceiver described in this disclosure may be implemented on integrated circuits (ICs), analog ICs, radio frequency integrated circuits (RFICs), mixed signal ICs, application specific integrated circuits (ASICs), printed circuit boards (PCBs), and electronic devices. The processor and the transceiver can also be produced using various IC process technologies, such as complementary metal oxide semiconductor (CMOS), nMetal-oxide- semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The communication device in the description of the above embodiments may be a network device or a terminal, but the scope of the communication device described in the disclosure is not limited thereto, and the structure of the communication device may not be limited by FIG. 22. The communication device may be a stand-alone device or may be part of a larger device. For example, the described communication device may be:

(1) a stand-alone IC, a chip, a chip system or a subsystem:

(2) a collection of ICs including one or more ICs, optionally, the collection of ICs may also include storage components for storing data and computer programs:

(3) an ASIC, such as a modem:

(4) a module that can be embedded within other devices:

(5) a receiver, a terminal, a smart terminal, a cellular phone, a wireless device, a handheld machine, a mobile unit, an in-vehicle device, a network device, a cloud device, an AI device, and the like: and

(6) others.

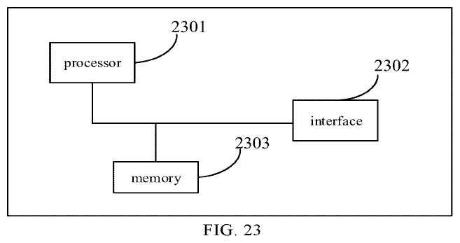

The case that the communication device is a chip or a chip system can be referred to the schematic diagram of the chip shown in FIG. 23. The chip shown in FIG. 23 includes a processor 2301 and an interface 2302. There may be one or more processors 2301, and there are a plurality of interfaces 2302.

Optionally, the chip further includes a memory 2303 for storing necessary computer programs and data.

It is understandable by those skilled in the art that various illustrative logical blocks and steps listed in the embodiments of the disclosure may be implemented by electronic hardware, computer software, or a combination of both. Whether such function is implemented by hardware or software depends on the particular application and the design requirements of the entire system. Those skilled in the art may, for each particular application, use various methods to implement the described function, but such implementation should not be construed as being beyond the scope of protection of the embodiments of the disclosure.

The disclosure also provides a readable storage medium having instructions stored thereon. When the instructions are executed by a computer, the function of any of the method embodiments described above is implemented.

The disclosure also provides a computer program product. When the computer program product is executed by a computer, the function of any of the method embodiments described above is implemented.

The above embodiments may be implemented in whole or in part by software, hardware, firmware, or any combination thereof. When implemented using software, the above embodiments may be implemented, in whole or in part, in the form of a computer program product. The computer program product includes one or more computer programs. When loading and executing the computer program on the computer, all or part of processes or functions described in the embodiments of the disclosure are implemented. The computer may be a general-purpose computer, a dedicated computer, a computer network, or other programmable devices. The computer program may be stored in a computer-readable storage medium or transmitted from one computer-readable storage medium to another computer-readable storage medium. For example, the computer program may be transmitted from one web site, computer, server, or data center to another web site, computer, server, or data center, in a wired manner (e.g., using coaxial cables, fiber optics, or digital subscriber lines (DSLs)) or wireless manner (e.g., using infrared wave, wireless wave, or microwave). The computer-readable storage medium may be any usable medium to which the computer is capable to access or a data storage device such as a server integrated by one or more usable mediums and a data center. The usable medium may be a magnetic medium (e.g., a floppy disk, a hard disk, and a tape), an optical medium (e.g., a high-density digital video disc (DVD)), or a semiconductor medium (e.g., a solid state disk (SSD)).

Those skilled in the art understand that “first”, “second”, and other various numerical numbers involved in the disclosure are only described for the convenience of differentiation, and are not used to limit the scope of the embodiments of the disclosure, or indicate the order of precedence.

The term “at least one” in the disclosure may also be described as one or more, and the term “multiple” may be two, three, four, or more, which is not limited in the disclosure. In the embodiments of the disclosure, for a type of technical features, “first”, “second”, and “third”, and “A”, “B”, “C” and “D” are used to distinguish different technical features of the type, the technical features described using the “first”, “second”, and “third”, and “A”, “B”, “C” and “D” do not indicate any order of precedence or magnitude.

The correspondences shown in the tables in this disclosure may be configured or may be predefined. The values of information in the tables are merely examples and may be configured to other values, which are not limited by the disclosure. In configuring the correspondence between the information and the parameter, it is not necessarily required that all the correspondences illustrated in the tables must be configured. For example, the correspondences illustrated in certain rows in the tables in this disclosure may not be configured. For another example, the above tables may be adjusted appropriately, such as splitting, combining, and the like. The names of the parameters shown in the titles of the above tables may be other names that may be understood by the communication device, and the values or representations of the parameters may be other values or representations that may be understood by the communication device. Each of the above tables may also be implemented with other data structures, such as, arrays, queues, containers, stacks, linear tables, pointers, chained lists, trees, graphs, structures, classes, heaps, and Hash tables.

The term “predefine” in this disclosure may be understood as define, define in advance, store, pre-store, pre-negotiate, pre-configure, solidify, or pre-fire.

Those skilled in the art may realize that the units and algorithmic steps of the various examples described in combination with the embodiments disclosed herein are capable of being implemented in the form of electronic hardware, or a combination of computer software and electronic hardware. Whether these functions are performed in the form of hardware or software depends on the specific application and design constraints of the technical solution. Those skilled in the art may use different methods to implement the described functions for each particular application, but such implementations should not be considered as beyond the scope of the disclosure.

It is clearly understood by those skilled in the field to which it belongs that, for the convenience and brevity of description, the specific working processes of the systems, apparatuses, and units described above may be referred to the corresponding processes in the preceding method embodiments, and will not be repeated herein.

The above are only specific implementations of the disclosure, but the scope of protection of the disclosure is not limited thereto. Those skilled in the art familiar to this technical field may easily think of changes or substitutions in the technical scope disclosed by the disclosure, which shall be covered by the scope of protection of the disclosure. Therefore, the scope of protection of the disclosure shall be governed by the scope of protection of the attached claims.

1. A third-party service management method, performed by a network exposure function (NEF) element, comprising:
receiving a first management request for managing a third-party service sent by an application function (AF) element, wherein the first management request indicates the third- party service that is provided by a third-party application;
managing the third-party service based on the first management request; and
sending a management result to the AF element.

2. The method of claim 1, wherein receiving the first management request for managing the third-party service sent by the AF comprises:
receiving a first registration request for registering the third-party service sent by the AF element, wherein the first registration request comprises registration information of the third-party service; and
the registration information comprising at least one of:
a network function (NF) identifier (ID) corresponding to the third-party service;
an NF type corresponding to the third-party service;
an NF supported service corresponding to the third-party service; or
a public land mobile network (PLMN) ID corresponding to the third-party application.

3. The method of claim 2, wherein managing the third-party service based on the first management request comprises:
determining whether the third-party service satisfies an authorization condition based on the registration information of the third-party service;
storing the NF ID corresponding to the third-party service in response to determining that the third-party service satisfies the authorization condition;
sending a second registration request for registering the third-party service to a network repository function (NRF) element, wherein the second registration request comprises the registration information and an NEF ID; and
receiving a registration success response sent by the NRF element,
wherein sending the management result to the AF element comprises sending a registration success response to the AF element.

4. (canceled)

5. The method of claim 2, wherein managing the third-party service based on the first management request comprises:
determining whether the third-party service satisfies an authorization condition based on the registration information of the third-party service; and
determining that registration of the third-party service has failed in response to the registration information of the third-party service not satisfying the authorization condition,
wherein sending the management result to the AF element comprises sending a registration failure response to the AF element.

6. (canceled)

7. The method of claim 1, wherein receiving the first management request for managing the third-party service sent by the AF element comprises:
receiving a first cancellation request for cancelling the third-party service sent by the AF element, wherein the first cancellation request comprises cancellation information of the third-party service; and
the cancellation information comprising at least one of:
an NF ID corresponding to the third-party service; or
a PLMN ID corresponding to the third-party application.

8. The method of claim 7, wherein managing the third-party service based on the first management request comprises:
determining whether the third-party service satisfies a cancellation condition based on the cancellation information of the third-party service;
sending a second cancellation request for cancelling the third-party service to an NRF element in response to determining that the third-party service satisfies the cancellation condition, wherein the second cancellation request comprises the cancellation information; and
deleting an NF ID corresponding to the third-party service in response to receiving a cancellation success response sent by the NRF element,
wherein sending the management result to the AF element comprises sending a cancellation success response to the AF element.

9. (canceled)

10. The method of claim 7, wherein managing the third-party service based on the first management request comprises:
determining whether the third-party service satisfies a cancellation condition based on the cancellation information of the third-party service; and
determining that cancellation of the third-party service has failed in response to the cancellation information of the third-party service not satisfying the cancellation condition,
wherein sending the management result to the AF element comprises sending a cancellation failure response to the AF element.

11. (canceled)

12. A third-party service management method, performed by a network repository function (NRF) element, comprising:
receiving a second management request for managing a third-party service sent by a network exposure function (NEF) element, wherein the second management request indicates the third-party service that is provided by a third-party application;
managing the third-party service based on the second management request; and
sending a management result to the NEF element.

13. The method of claim 12, wherein receiving the second management request for managing the third-party service sent by the NEF element comprises:
receiving a second registration request for registering the third-party service sent by the NEF element, wherein the second registration request comprises registration information of the third-party service and an NEF identifier (ID);
the registration information comprising at least one of:
a network function (NF) ID corresponding to the third-party service;
an NF type corresponding to the third-party service;
an NF supported service corresponding to the third-party service; or
a public land mobile network (PLMN) ID corresponding to the third-party application.

14. The method of claim 13, wherein managing the third-party service based on the second management request comprises at least one of:
generating a configuration file for registering the third-party service based on the registration information of the third-party service and the NEF ID; or
setting an available status corresponding to the third-party service to be as available,
wherein sending the management result to the NEF element comprises sending a registration success response to the NEF element.

15. (canceled)

16. The method of claim 14, further comprising:
sending a first notification message to a specific NF element, wherein the specific NF element is a network element that has subscribed to a service change event, and the first notification message indicates that registration of the third-party service has completed.

17. The method of claim 12, wherein receiving the second management request for managing the third-party service sent by the NEF element comprises:
receiving a second cancellation request for cancelling the third-party service sent by the NEF element, wherein the second cancellation request comprises cancellation information of the third-party service;
the cancellation information comprising at least one of:
an NF ID corresponding to the third-party service; or
a PLMN ID corresponding to the third-party application.

18. The method of claim 17, wherein managing the third-party service based on the second management request comprises at least one of:
deleting a configuration file corresponding to the third-party service based on the cancellation information corresponding to the third-party service; or
setting an available status of the third-party service to be as unavailable,
wherein sending the management result to the NEF element comprises sending a cancellation success response to the NEF element.

19. (canceled)

20. The method of claim 18, further comprising:
sending a second notification message to a specific NF element, wherein the specific NF element is a network element that has subscribed to a service change event, and the second notification message indicates that cancellation of the third-party service has completed.

21. A third-party service management method, performed by an application function (AF) element, comprising:
sending a first management request for managing a third-party service to a network exposure function (NEF) element, wherein the first management request indicates the third- party service that is provided by a third-party application; and
receiving a management result sent by the NEF element.

22. The method of claim 21, wherein sending the first management request for managing the third-party service to the NEF element comprises: sending a first registration request for registering the third-party service to the NEF element, wherein the first registration request comprises registration information of the third-party service;
the registration information comprising at least one of:
a network function (NF) identifier (ID) corresponding to the third-party service;
an NF type corresponding to the third-party service;
an NF supported service corresponding to the third-party service; or
a public land mobile network (PLMN) ID corresponding to the third-party application,
wherein receiving the management result sent by the NEF element comprises at least one of:
receiving a registration success response sent by the NEF element; or
receiving a registration failure response sent by the NEF element.

23-24. (canceled)

25. The method of claim 21, wherein sending the first management request for managing the third-party service to the NEF element comprises: sending a first cancellation request for cancelling the third-party service to the NEF element, wherein the first cancellation request comprises cancellation information of the third-party service; and
the cancellation information comprising at least one of:
an NF ID corresponding to the third-party service; or
a PLMN ID corresponding to the third-party application,
wherein receiving the management result sent by the NEF element comprises at least one of:
receiving a cancellation success response sent by the NEF element; or
receiving a cancellation failure response sent by the NEF element.

26-27. (canceled)

28. A network exposure function (NEF) element configured to perform the third-party service management method according to claim 1.

29. A network repository function (NRF) element configured to perform the third-party service management method according to claim 12.

30. An application function (AF) element configured to perform the third-party service management method according to claim 21.

31-34. (canceled)
